(19) United States
(12) Patent Application Publication
(10) Pub. No.: US 2004/0205012 A1
(43) Pub. Date: Oct. 14, 2004

(54) Charitable income strategy

(76) Inventor: James J. O'Connor, Longwood, FL (US)

Correspondence Address: WILLIAM J. MASON, MACCORD MASON PLLC, POST OFFICE BOX 1489, WRIGHTSVILLE BEACH, NC, 28480, US

(21) Appl. No.: 10/412,887

(22) Filed: Apr. 14, 2003

(51) Int. Cl. G06F 17/60

(52) U.S. Cl. 705/36

(57) ABSTRACT

Income is generated income for a charity using a combination of one or more immediate annuities and a life insurance policy. A designated individual serving as the annuitant and insured is selected from participating members of the charity based on the age and insurability of available participating members, so that the annuity payments will be greater than the insurance premiums and any interest on the funds source. A life insurance policy having a face value equal to the amount of the investment funds is purchased. A first immediate annuity is purchased with a portion of the available investment funds, with the payments from the first annuity being sufficient to pay the premiums on the life insurance policy. Life insurance proceeds are used to reimburse the funds source upon the death of the participating member. If investment funds are borrowed, other annuity payments may be used to pay loan interest.

### BACKGROUND OF THE INVENTION

(1) Field of the Invention

The present invention relates to the use of immediate annuities to generate income for charities, and in particular to immediate annuities based on the expected lifetime of the functional member of a charity.

(2) Description of the Prior Art

Immediate annuities provide a guaranteed income in the form of monthly, quarterly, semi-annual or annual payments in exchange for a one-time lump sum paid to the annuity company. Payments can be received over a specific period of time, a single lifetime, or a joint lifetime. The amount of the payments depends not only on the amount of the one-time lump sum, but also on the actuarially projected life of the annuitant. Payout rates on a lifetime annuity are significantly higher when the annuitant is older.

The obligation of the annuity company to pay under an immediate lifetime annuity ends upon the death of the annuitant. If the funds used to purchase the annuity are less than the payments made by the company at the time of death, the company profits. If not, the company takes a loss. Income received by the company from the reinvestment of the purchase amount is also taken into account. In any event, the investment amount is not returned to the purchaser of the annuity. Thus, if the annuitant dies soon after the annuity is purchased, the purchaser of the annuity, or the annuitant's estate, could take a substantial loss.

In order to protect against the loss, a portion of the payments from the immediate annuity can be used to purchase a life insurance policy in an amount at least equal to the amount invested in the annuity. Upon the death of the annuitant, the proceeds from the insurance policy are used to reimburse the purchase amount.

Using income from an immediate annuity to pay the premiums on a life insurance policy is a well-known technique used by senior aged individuals. Basically, the individual purchases an immediate annuity for a given investment, with the terms of the immediate annuity being such that guaranteed payments are made to the individual over his or her lifetime. The individual also purchases the annuity, paying the premiums on the life insurance policy with a portion of the annuity income. Upon the individual's death, the annuity terminates and the life insurance proceeds are paid to the individual's estate, or to the actual owner of the life insurance, such as an irrevocable life insurance trust.

In a variation of this strategy, the individual borrows funds to purchase the annuity and life insurance policy. Depending upon the actuarial life expectancy and health of the individual, the income from the annuity may be greater than necessary to pay the life insurance premiums and the interest on the loan. Upon the death of the individual, the annuity terminates and the proceeds of the life insurance policy are used to repay the loan.

Investment strategies based on immediate annuities coupled with life insurance policies have also been used by companies on behalf of employees, particularly management personnel who are also major stockholders. However, this strategy has not heretofore been applied to the generation of income, or excess asset value, by charities using the charities own funds or borrowed funds.

### SUMMARY OF THE INVENTION

Most charities are conservative regarding investments, often investing in bonds, Certificates of Deposit, money market funds, and/or treasuries. In today's marketplace, these investments only produce a modest rate of return. The present invention is directed as a method to be used by a charity to increase the income, and/or assets from the investment of the charity's own funds, funds received as gifts, or loans from third parties.

In accordance with the present invention, a charity is able to invest its own funds in immediate annuities yielding substantially higher rates of income stream as compared to alternative investments, and do so on a guaranteed basis. In addition, charities can generate additional income, and/or additional assets by purchasing immediate annuities using funds acquired through loans. This can be accomplished for additional income when the income from the annuities is greater than needed to pay the obligations of the investment strategy, thereby generating excess income for the charity's use.

This can be accomplished to create additional assets for the charity when the amount applied to the immediate annuities is sufficient, on a guaranteed basis, to pay the loan interest for the loan, and to pay the premium needed to purchase life insurance equal to the loan outstanding. The excess funds that were not applied to the process, since the process is guaranteed, are available as an additional asset of the charity and for the charity's use.

The key to the present method is the identification of the individual who will serve as the annuitant. In the present invention, the annuitant for purposes of annuity purchases, is a designated active member of the given charity, this could include but is not limited to a board member or a trustee. This person is referred to herein as a “participating member.” In order for the present method to generate income for the charity, the actuarial life of the designated individual should be such that the immediate annuity will generate an income more than sufficient to pay the premiums on the life insurance policy. If the immediate annuity is purchased with borrowed funds, the income from the immediate annuity should be more than sufficient to pay the life insurance premiums, plus the obligations on any loans. The designated annuitant should also be in insurable heath. Normally, the participating member will be at least 75 years old. Depending on the age and health of the individual, an immediate annuity should be able to pay out a substantial income. The amount that can be paid out changes from time to time, but is guaranteed by the annuity carrier at the time it receives funds to be placed in the annuity. The payout rate is based on rates that annuity carriers receive on underlying investments, as well as the actuarial assumptions about the life expectancy of the annuitant at the time of issue. Currently, at the time of this writing, it is not uncommon to see guaranteed payout rates equal to 10% to 20% of the fuinds invested in the annuity, when the annuitant is over age 75.

Thus, the present method for use by a charity comprises the steps of purchasing an immediate annuity for a given invested amount, and purchasing a life insurance policy having a payout at least equal to the invested amount, using as the selected annuitant and insured a participating member of the charity whose actuarial life expectancy is such that the income generated from the annuity is greater than the premiums on the life insurance policy.

In the event that the annuity is purchased with borrowed funds, the present method for use by a charity comprises the steps of borrowing funds, purchasing an immediate annuity for a given invested amount using a portion of the borrowed funds, and purchasing a life insurance policy having a payout at least equal to the invested amount with a portion of the funds, using as the selected annuitant and insured a participating member of the charity whose actuarial life expectancy is such that the income generated from the annuity is greater than the premiums on the life insurance policy and any funds required to pay interest on the loan. The excess funds that were borrowed and not part of this process would be available for use by the charity, or to increase the asset value of the charity.

Either of the above methods may be modified by the purchase of multiple annuities, instead of a single annuity. For example, a first immediate annuity can be purchased for a first amount sufficient to generate an income stream at least equal to the premiums required to purchase the life insurance policy, while a second annuity can be purchased for a second amount sufficient to generate an income stream at least equal to the interest payments due on the loan. Excess income from the annuity or loan can be used for purposes of the charity.

### BRIEF DESCRIPTION OF THE DRAWINGS

FIG. 1 is a diagrammatic illustration of the strategy using the charity's own money or contributions.

FIG. 2 is a diagrammatic illustration of the strategy using borrowed funds.

FIG. 3 is a diagrammatic illustration of the strategy using a charitable gift.

FIG. 4 is a diagrammatic illustration of the strategy using funds borrowed from a CRT or foundation.

FIG. 5 is a diagrammatic illustration of the strategy using funds borrowed from an individual.

### DETAILED DESCRIPTION OF THE INVENTION

The following examples illustrate implementation of the charitable income strategy using different funding sources. For clarity of illustration, the examples will describe the purchase of two immediate annuities, with the income from one annuity being used to pay premiums on a life insurance policy, and income from the other annuity being used to pay other obligations, or fund the charity. In certain applications of this strategy, excess asset value will be available for the charity's use after the purchase of these annuities. It will be understood, however, that a single annuity may be purchased, with the proceeds being allocated among the various uses.

The examples also make various assumptions regarding the age of the functioning member, the interest rate of loans, and the rate of return on the immediate annuities. While these amounts are based on interest rates, it will be understood that the actual results will differ when using values different from those used in the examples. Generally, however, once purchased, the rate of return from an immediate annuity will not change, regardless of fluctuating interest rates or other economic changes.

### EXAMPLE 1

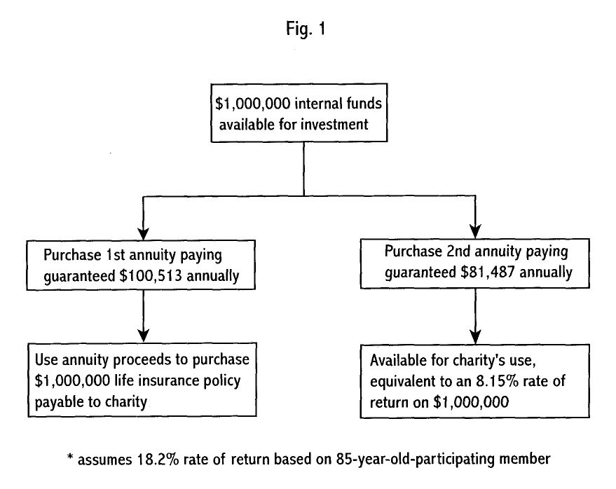

FIG. 1 illustrates the funding of a strategy by Charity A using $1,000,000 of its own funds or contributions to purchase two immediate annuities. The measured life of the annuities is based on the actuarial life of a participating member of the charity, in this example, an 85-year-old male.

The first immediate annuity is purchased with $552,269 of the $1,000,000 of available funds. Currently, the annuity returns an income stream at the rate of 18.2%, based on the age of the participating member. This creates an income stream of $100,513 annually, and guaranteed for life. This amount, which inside of the charity should be income tax free, is used to pay the premiums on a life insurance policy naming the charity as the beneficiary. The life insurance policy chosen will have a guaranteed premium so that if the policy premiums are paid on time the policy will be guaranteed.

After this application there is still $447,731 of the $1,000,000 available, and these funds are used to purchase a second annuity, on the life of the same annuitant, and also generating an income stream with a rate of 18.2%. This creates an income stream of $81,487, annually, and guaranteed for life. This is equivalent to approximately an 8.15% rate of income stream against the total $1,000,000. These funds are available for the charity's use. Again, this amount should also be considered a passive investment of the charity and, therefore, not taxable.

### EXAMPLE 2

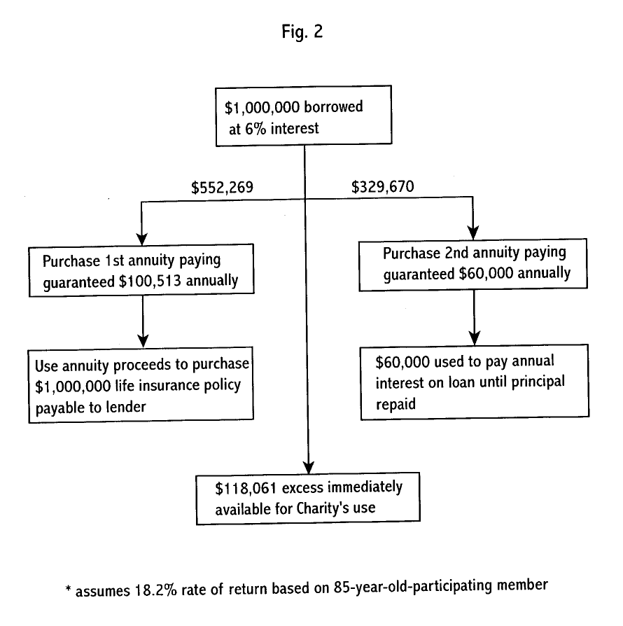

FIG. 2 illustrates the use of borrowed funds instead of internal or contributed funds to implement the above strategy. As in Example 1, two immediate annuities are purchased, using as the measured life for the immediate annuities and the life insurance, a participating member of the charity, which in our example is a male age 85. However, the $1,000,000 to fund the strategy is borrowed at an interest rate assumed to be 6% for purposes of this example.

As in Example 1, we apply the first $552,269 of the $1,000,000 to purchase a first immediate annuity life. Again, the rate of income equals 18.2% and is $100,513 annually, and guaranteed for life. This annual stream of income is used to purchase a life insurance policy, naming the charity as beneficiary. The death benefit purchased will provide the capital needed to pay back the borrowed funds. The policy is collaterally assigned to the lender.

After this application, there is still $447,731 of the $1,000,000 of borrowed funds still available. In this application, a second annuity is purchased, on the same male 85 participating member of the charity with $329,670 of the remaining $447,731. At an 18.2% rate of income, this second annuity will generate an annual income of $60,000 guaranteed for life. The income from this annuity equals the rate of interest charged on the $1,000,000, and the charity may use this income stream to pay each year's loan interest due.

With these first two annuity purchases, and the life insurance purchase, we have created a process by which to 1) pay the loan interest due each yearn on borrowed funds, and 2) create a future asset, in the form of life insurance proceeds that is equal to the outstanding loan, and can be used to repay the loan in full. After these applications, there is still $118,061 of the borrowed funds that are now available for the charity's use.

### EXAMPLE 3

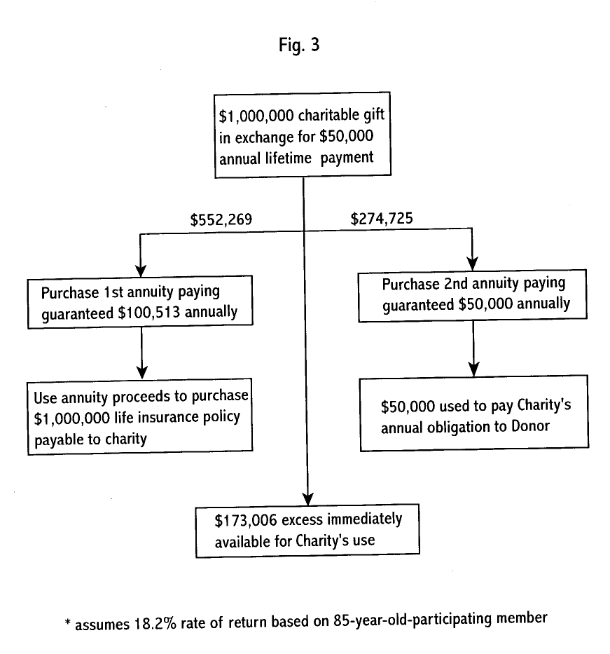

FIG. 3 illustrates the use of a charitable gift to implement the above strategy. As in Example 1, two immediate annuities are purchased, using as the measuring life a participating member of the charity male age 85.

In this example, however, the $1,000,000 used to fund the strategy is a charitable gift made by an individual donor (not the participating member) in exchange for the charity's promise to pay the donor a 5% income stream from the value of the gift at the time it is delivered to the charity. In this example, 5% of %1,000,000 represents a promise to pay the donor $50,000 each year of the donor's life. The donor also receives a charitable deduction for the gift.

As in Example 1, the charity will apply $552,269 of the $1,000,000 to purchase an immediate annuity on the life of the participating member, who is a male age 85 in our example. At a stream of income equal to 18.2%, this will create an annual income of $100,513 guaranteed for the life of the participating member, male age 85. This income stream is then used by the charity to purchase $1,000,000 of life insurance on that same male age 85.

A second immediate annuity is purchased with $274,725 of the $447,731 of the remaining gift proceeds. At an 18.2% rate of return on the income stream, this second annuity generates $50,000 annual income, guaranteed for the life of the annuitant, (measuring life of the participating member). This income (of $50,000) is used to pay the charity's obligation to the donor.

The balance of the $1,000,000 is $173,006, and is available for the charity's use. This excess income can also be annualized to create an additional income for the charity, or it can be used as an additional asset of the charity.

At the death of the participating member of the charity who is the measuring life, the charity would receive $1,000,000 of proceeds from the life insurance policy. The charity then has the choice to find another participating member of the charity to continue this strategy, or use a different investment at the time. Should the charity continue with this strategy, and then ultimately, the charity should receive the full donation of the $1,000,000 for its own use.

### EXAMPLE 4

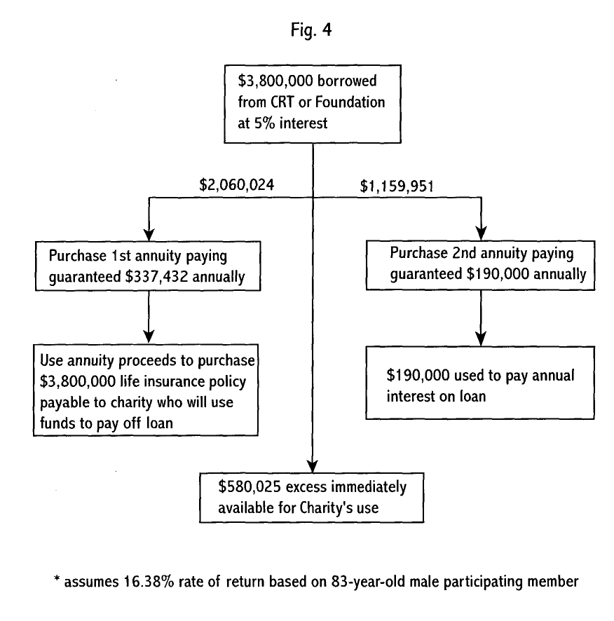

FIG. 4 illustrates the use of $3,800,000 borrowed from a charitable remainder trust or foundation to implement the strategy. Two immediate annuities are purchased, using as the actuarial life expectancy of a participating member of the charity, an 83-year-old male. Due to the relationship between the parties, the terms of the loan in the amount of $3,800,000 are flexible and the interest rate is assumed to be 5%.

A first immediate annuity is purchased with $2,060,024 of the $3,800,000 of loan proceeds. With a participating member of the charity male age 83, as the measuring life, this annuity should have a rate of return on the income stream of 16.38%, which is the annual payment of $337,432 guaranteed for life. These proceeds are used to pay the premiums on a life insurance policy in the amount of $3,800,000 naming the charity as beneficiary, with the proceeds of the policy being collaterally assigned to the CRT, or, Foundation.

A second immediate annuity is purchased with $1,159,951 of the remaining loan proceeds. At a rate of return of the income stream of 16.38%, this second annuity generates $190,000 annually and guaranteed for life. This income stream is used to pay the interest on the loan, which is 5% in the amount of $190,000 (5%). The balance of funds in this example is $580,025, and is immediately available for the charity's use.

### EXAMPLE 5

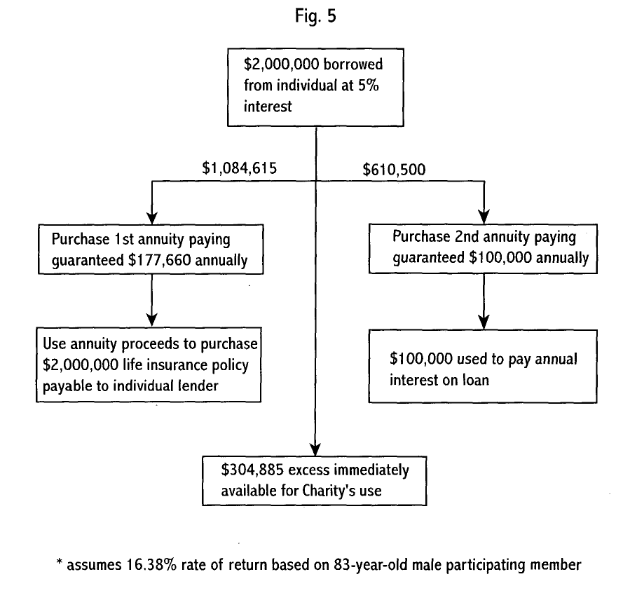

FIG. 5 illustrates the use of $2,000,000 borrowed from an individual to implement the strategy. As in Example 1, two immediate annuities are purchased, using the measuring life of a participating member of the charity as the measuring life for this strategy, which in this example is a male age 83. The loan rate is assumed to be 5%.

A first immediate annuity is purchased with $1,084,615 of the $2,000,000 of loan proceeds, generating a stream of income in the amount of $177,660 and a rate of return on the income stream of 16.38%. These proceeds are used to pay the premiums on a life insurance policy in the amount of $2,000,000 payable to the charity. The policy values can also be collaterally assigned to the lender.

A second annuity is purchased with $610,050 of the remaining loan proceeds. This annuity will generate an annual income of $100,000 guaranteed for life, which is used to pay the interest on the loan. The balance of proceeds is $304,885 and is immediately available for the charity's use.

If desired, a software program used on a computer may be used to select the participating member from among potential participating members available within the charity. The software program can also be used to calculate such factors as the amount of the annuity that must be purchased to cover premiums on a life insurance policy having a payout equal to the amount of funds invested.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method for generating income for a charity comprising:
a) purchasing at a given purchase price at least one immediate annuity providing periodic payments to said charity, the term of the annuity being the remaining life of a selected participating member of said charity; and
b) paying premiums on a life insurance policy naming the participating member as the insured from payments received from said annuity, the amount of said policy being at least equal to the given purchase price, the payments received from said annuity being greater than the premiums on said life insurance policy.

2. The method of claim 1, wherein said annuity is purchased with funds of the charity.

3. The method of claim 1, wherein said annuity is purchased with borrowed funds that are repaid upon the death of the participating member with proceeds from said life insurance policy.

4. The method of claim 1, wherein said annuity is purchased with funds from a charitable gift from a donor to the charity, with the charity having an obligation to make payments to the donor, with the payments from said annuity being used to pay the premiums on said life insurance policy and the payments to said donor.

5. The method of claim 1, wherein the participating member is selected from other participating members of the charity based on the age and insurability of available participating members in order to provide the highest rate of return on the annuity.

6. The method of claim 1, wherein said participating member is a board member or trustee of said charity.

7. The method of claim 1, wherein said participating member is at least 75 years of age.

8. The method of claim 1, wherein said annuity is purchased with borrowed funds, and the payments from said annuity are used to pay the premiums on said life insurance policy and the interest on said borrowed funds.

9. The method of claim 1, wherein first and second annuities are purchased, each of said annuities providing payments to said charity, the payments from said first annuity being used to pay the premiums on said life insurance policy, and the payments from said second annuity being used for other purposes of said charity.

10. A method for generating income by a charity comprising:
a) borrowing a given amount of funds from a lender naming said charity as the debtor;
b) purchasing an immediate annuity providing periodic payments to said charity with said borrowed funds, the term of the annuity being the remaining life of a selected participating member of said charity;
c) purchasing a life insurance policy, the amount of said policy being at least equal to the amount of funds borrowed; and
d) paying the premiums on said life insurance policy and the interest on the borrowed funds from payments received from said annuity, the actuarial life of the participating member being such that excess funds for use by the charity are available from annuity payments after payment of the insurance premiums and interest.

11. The method of claim 10, wherein the borrowed funds are repaid with proceeds from the life insurance policy upon the death of the participating member.

12. The method of claim 10, wherein the charity is the named insured on the life insurance policy.

13. The method of claim 10, wherein the lender is the named insured on the life insurance policy.

14. The method of claim 10, wherein the participating member is selected from other participating members of the charity based on the age and insurability of available participating members in order to provide the highest rate of return on the annuity.

15. The method of claim 10, wherein said participating member is a board member or trustee of said charity.

16. A method of generating income for a charity using a given amount of investment funds from a funds source comprising:
a) selecting a designated individual from participating members of the charity based on the age and insurability of available participating members;
b) determining the amount of premiums required to purchase a life insurance policy having a face value equal to the amount of said investment funds and naming the participating member as the insured;
c) purchasing a first immediate annuity with a portion of said investment funds naming the selected participating member as the annuitant, the value of said first annuity being sufficient to pay the premiums on said life insurance policy; and
d) purchasing a life insurance policy having a face value equal to the amount of said investment funds and naming the participating member as the insured; and
e) using the proceeds of the life insurance policy to reimburse the funds source for said investment funds upon the death of the participating member.

17. The method of claim 16, wherein a computer program is used to select the participating member and determine the amount of the required annuity.

18. The method of claim 16, wherein the funds source is funds of the charity, and a portion of said investment funds in excess of the amount required to purchase said first annuity are used to purchase a second annuity naming the participating member as the annuitant, payments from the second annuity being made to the charity for charitable purposes.

19. The method of claim 16, wherein the funds source is a loan, and a portion of said investment funds in excess of the amount required to purchase said first annuity are used to purchase a second annuity, the payments from the second annuity being used to pay interest on the loan.

20. The method of claim 19, wherein a portion of said loan is used directly by the charity for charitable purposes.
